(19) United States
(12) Patent Application Publication
(10) Pub. No.: US 2002/0072326 A1
(43) Pub. Date: Jun. 13, 2002

(54) Intelligent radio

(76) Inventors: Safi Qureshey, Santa Ana, CA (US); Wasi Qureshey, Irvine, CA (US)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/933,568

(22) Filed: Aug. 20, 2001

Related U.S. Application Data
(63) Continuation of application No. 09/096,703, filed on Jun. 12, 1998, now abandoned.
(60) Provisional application No. 60/072,127, filed on Jan. 22, 1998.

(51) Int. Cl. H04H 1/00

(52) U.S. Cl. 455/3.02; 455/3.06; 455/344; 455/142

(57) ABSTRACT

An intelligent radio apparatus that is adapted to receive Web radio broadcasts is disclosed. The Web Radio provides a user interface that is less like a computer program and more like a conventional radio, thus making the device easy to use. Rather than the complicated user interface found on Personal computers, the intelligent radio provides familiar radio-type user controls such as switches, a tuning knob, joysticks, cursor controls, voice activated controls, etc. The radio-type user controls allow the user to select a Web radio station and control other aspects of the operation of the intelligent radio in a manner that is more like a conventional radio and less like a computer program. The intelligent radio is configured to run the software needed to access the Internet and thus relieves the user of complicated software installation tasks such as installing and configuring an operating system and installing and configuring Internet access software. The intelligent radio also provides Internet telephony, voicemail, and voice-email capabilities.

### REFERENCE TO PRIOR RELATED APPLICATION

This application is a continuation of U.S. application Ser. No. 09/096,703, filed Jun. 12, 1998, and titled “INTELLIGENT RADIO.”

### BACKGROUND OF THE INVENTION

1. Field of the Invention

The present invention relates to the field of reception of audio programming, and, more particularly, relates to the field of transmission and reception of streaming audio over a computer network such as the Internet.

2. Description of the Related Art

The Internet is a worldwide array of interconnected computers and information servers that allow anyone with a computer and access to the Internet to get information about virtually any subject 24 hours a day. For the average consumer, an Internet Service Provider (ISP) provides access to the Internet. ISPs such as CompuServe, Prodigy, and America On-Line, currently link over ten million users to the Internet. Users typically connect to the ISP by using standard telephone lines and a telephone modem. Cable modems that allow a user to connect to the ISP over cable television lines, and satellite connections to the Internet, are also available.

The Internet provides a wealth of information from stock reports to headline news. One of the newer services provided on the Internet is a streaming audio (e.g., RealAudio and MPEG audio) service. Streaming audio services are often provided in connection with the World Wide Web (Web) and thus are often called Web radio broadcasts. With streaming audio, a user with a Personal Computer (PC), a sound card, and the necessary software can listen to audio programs from anywhere in the world. For example, Radio Prague provides daily Internet broadcasts from the Czech Republic. Listeners in the U.S. can listen to these Web radio broadcasts either in real time, or stored for later replay. Thus, unlike more traditional radio broadcasts where the listener must be within a reception area, Web radio broadcasts can be heard anywhere, so long as the listener has a connection to the Internet and the necessary computer hardware and software.

Unfortunately, even with the ever-decreasing cost of personal computers, the hardware and software needed to listen to a Web radio broadcast is beyond the financial means of many people. Even for those that can afford a personal computer, listening to a Web radio broadcast ties up the computer so that the user cannot use it for other purposes. Moreover, the use of a personal computer to receive streaming audio (e.g., Web radio broadcasts) requires a certain amount of computer literacy on the part of the user. The user must be able to install the Web Radio software, configure the Web Radio software to communicate with the ISP, and find the various Web radio broadcasts provided on the Web.

### SUMMARY OF THE INVENTION

Embodiments of the present invention solve these and other problems by providing an intelligent radio apparatus that is adapted to allow a user to receive Web radio broadcasts in a manner similar to the ease and low cost with which a user receives a regular radio broadcast. Embodiments of the intelligent radio also provide Internet telephony, voicemail, text-to-voice email, voice-to-text email, and voice activated commands. These features are provided in a simple, low-cost, easy-to-use device.

A preferred embodiment of the intelligent radio apparatus relieves the user of the complicated tasks associated with installing and configuring computer software. The intelligent radio apparatus also preferably provides a user interface that is less like a computer program and more like a conventional radio, thus making the device easy to use. In a preferred embodiment, the user controls provided by the intelligent radio are so similar to the controls provided on a conventional AM radio or FM radio that a non-technical user can tune into Web radio broadcasts or AM/FM radio broadcasts with similar ease. When compared to a full-fledged computer, such as a laptop or desktop computer, the intelligent radio typically provides lower cost, smaller size, lower power consumption, less upkeep and maintenance, and more convenience.

Various embodiments of the intelligent radio include user controls such as switches, a tuning knob, joysticks, cursor controls, remote controls, etc. The user controls allow the user to select a Web radio station and control other aspects of the operation of the intelligent radio. In some embodiments, the user controls are configured such that the intelligent radio operates more like a conventional radio and less like a computer program. For example, in one embodiment, the intelligent radio includes a tuning knob that allows the user to “tune” Web radio stations from a list of available Web radio stations. The user turns the tuning knob to move from one Web radio station in a manner similar to the way a user would use the tuning knob on a conventional radio to tune from one radio station to another. The intelligent radio provides each selection of Web radio broadcasts by categories such as, for example, language, content, subject matter, etc.

The intelligent radio apparatus includes a visual display for providing information to a user, a network interface (e.g., a modem) for transmitting and receiving digital data over a communications network, and embedded software adapted to connect to the Web and to decode streaming audio. The communications network may be telephone lines, cable TV lines, satellite communication systems, etc.

In an alternative embodiment, the intelligent radio apparatus also includes loudspeakers for playing the broadcasts. Other embodiments include a data storage device for storing software and audio files.

In other embodiments, the intelligent radio apparatus is adapted to be installed in an automobile, boat, airplane, or other vehicle. In yet another embodiment, the intelligent radio apparatus is adapted to be a portable device much like a conventional transistor radio.

In yet another embodiment, the intelligent radio is configured to work in connection with service routines running on a remote computer connected to a computer network. The remote computer may be an Internet site (e.g., a web site or ISP) that provides additional functionality to the intelligent radio. For example, the intelligent radio may include a microphone to allow voice-activated commands to be used for controlling the intelligent radio. Voice recognition software to interpret the voice commands may be provided in either the intelligent radio or in the remote computer. If the voice recognition software is located in the remote computer, then the intelligent radio digitizes the voice data and passes the digitized voice data to the remote computer. The remote computer converts the voice data into computer commands and passes the command to the intelligent computer. In some embodiments, service routines in the remote computer are used to offload other tasks as well, including, for example, formatting the display, searching the Internet for radio web sites, converting audio and other data from one format to another format, etc. Offloading tasks to the remote computer simplifies the intelligent radio and reduces the size and cost of the intelligent radio without sacrificing functionality. Moreover, the software in the remote site can be kept up-to-date at all times without updating the software in the intelligent radio.

In yet another embodiment, the intelligent radio is configured to provide Internet telephone services to a user by connecting a telephone or telephone handset to the intelligent radio. An Internet telephone connection, that provides streaming audio, is established between the intelligent radio and a remote unit such as an intelligent radio, computer, or telephone system. When the user speaks into the handset, the user's voice is digitized and passed to the remote unit where it is converted to audio for the user of the remote unit. Likewise, the remote user's speech is digitized and passes as a stream of digital data to the intelligent radio where it is converted into audio and provided to a loudspeaker in the telephone handset.

### BRIEF DESCRIPTION OF THE FIGURES

The various novel features of the invention are illustrated in the figures listed below and described in the detailed description that follows.

FIG. 1 is a perspective view of one embodiment of a tabletop intelligent radio apparatus.

FIG. 2 is a block diagram of the functional elements of the intelligent radio apparatus.

FIG. 3A shows a default display that appears while a Web broadcast is being received.

FIG. 3B shows a menu display that allows the user to select one of the command and setup displays shown in FIGS. 3C-3E.

FIG. 3C illustrates a select language display that allows a user to specify desired languages (e.g., English, French, etc.).

FIG. 3D illustrates a display that allows a user to select a type of program material (e.g., news, sports, weather, etc.).

FIG. 3E illustrates a display that allows a user to select various program broadcasts.

FIG. 4 illustrates a data-entry display that the intelligent radio apparatus uses to allow the user to input alphanumeric text.

FIG. 5 is a flowchart that illustrates operation of the intelligent radio apparatus.

FIG. 6A illustrates the information management and data processing functions provided by a Web radio Web site (e.g., www.webradio.com) to produce a list of Web radio broadcast stations for the user.

FIG. 6B illustrates a relationship between the Web radio Web site and other web sites that provide streaming audio programming.

FIG. 7 is a perspective view of a tabletop intelligent radio tuner.

FIG. 8 is a block diagram of the functional elements of the intelligent radio tuner shown in FIG. 7.

FIG. 9 is a block diagram of the functional elements of an embodiment of the intelligent radio that provides a remote playback capability.

FIG. 10 is a block diagram of the functional elements of an embodiment of the intelligent radio that provides a remote access capability.

In the figures, the first digit of any three-digit number indicates the number of the figure in which the element first appears. For example, an element with the reference number 502 first appears in FIG. 5. Where four-digit reference numbers are used, the first two digits indicate the figure number.

### DETAILED DESCRIPTION OF THE PREFERRED EMBODIMENT

One aspect of the present invention is an intelligent radio device that allows a user to receive digitized radio broadcasts over the World Wide Web (Web). The intelligent radio provides the hardware and software necessary to receive digitized radio from the Web without the need for a personal computer or other expensive equipment. The intelligent radio provides a display device, such as a Liquid Crystal Display (LCD) that allows the user to select a desired Web broadcast from a list of available Web broadcasts. The display also allows the user to select Web broadcasts in a particular language. The software, the user controls, and the display in the intelligent radio 100 are operably configured and connected such that a user can tune into a Web radio broadcast in a manner similar to the way a user would use the controls on a conventional radio to tune into an AM or FM radio station. Thus, the intelligent radio provides people who are not comfortable with computers, or who do not own or have access to a computer, an opportunity to listen to streaming audio information from the Internet.

In one embodiment, the intelligent radio is a low-cost tabletop box that connects to an AC power line and a phone line. The device includes a display device, speakers, a control panel, a computer processor, a stored software program, and a modem. The intelligent radio uses the modem to establish a telephone connection to an Internet Service Provider (ISP). The stored software program connects to a Web Radio home page, via the ISP, and downloads a list of Web radio station addresses. Alternatively, the user may enter a web address (e.g., a Uniform Resource Locator (URL)) to connect directly to a web page that provides audio broadcasts (instead of first connecting to the Web Radio home page). The user may use buttons on the control panel to scroll through the display and select a Web radio broadcast “station” for listening. When a station is selected, the stored software program connects to the station and begins to receive digitized audio data transmitted by the station. The intelligent radio converts the received data to analog audio and plays the audio on one or more loudspeakers.

In an alternate embodiment, the intelligent radio is a tuner that connects to an audio system such as a component stereo system. The tuner provides an audio output to the audio system. The audio system provides amplifiers and loudspeakers. The tuner comprises an enclosure that connects to an AC power line, a network line, and the audio system. The network line may be any type of computer data connection, including, for example, a telephone line, a cable line, an Ethernet line, a Token-Ring line, a twisted pair line, an infrared link, a radio frequency link, an IEEE-1394 FireWire line, etc. The tuner includes a display device, a control panel, a computer processor, a stored software program, and a modem. The intelligent radio uses the modem to establish a telephone connection to an Internet Service Provider (ISP). The stored software program connects to a Web Radio home page, usually provided by the ISP, and downloads a list of Web radio stations. A user uses use buttons on the control panel (or remote control) to scroll through the display and select a Web radio broadcast “station” for listening. Alternatively, the user may use voice-activated commands to scroll through the display. When a station is selected, the stored software program connects to the station and begins to receive digitized audio data transmitted by the station. The intelligent radio converts the received data to analog audio, which is provided to the audio system.

FIG. 1 illustrates one embodiment of a tabletop intelligent radio 100. The intelligent radio 100 is mounted in an enclosure 101 and connects to household AC power through a power cord 104 and to a communications network by a network cable 102. The network cable 102 may be a telephone line, a network cable, a cable TV cable, a connection to a wireless (e.g., satellite) unit, etc. For example, the communications network may use Iridium satellites developed by the Motorola Corp., Globalstar satellites developed by a consortium of European manufacturers which includes Aerospatiale and Alcatel, P21 satellites developed on a project financed by Imarsat, or the Odyssey satellite system developed by a TRW consortium associated with Teleglobe/Canada.

User controls are mounted on the front of the enclosure 101 and include a combined on-off and volume control 110, a command button 121, a cursor control 116, a select button 118, a tuning control 114, and a button bar 120. The cursor control 116 provides up, down, left, and right movements of a cursor or other entity on a display device 112. The button bar 120 provides buttons to select an audio source, including, for example, “AM” radio, “FM” radio, “Web” radio, “Cassette”, and “External” input. Also mounted on the front of the enclosure 101 is the display device 112, which provides information to the user. An optional cassette player/recorder 130 provides the capability to play and record audio cassettes. The intelligent radio 100 also includes a left stereo speaker 106 and a right stereo speaker 108 that may be mounted in the enclosure 101 or in separate enclosures. A wireless remote 135 provides remote operation of the intelligent radio 100. In some embodiments, a microphone is provided as well. An output from the microphone is provided to an analog-to-digital converter to convert the analog microphone signal into digital data. The microphone may be placed in the intelligent radio 100, in the wireless remote 135, or both.

FIG. 2 is a block diagram of the functional elements of the intelligent radio 100. The intelligent radio 100 comprises a Central Processor Unit (CPU) 202 that is used to run the intelligent radio software. The CPU 202 is connected to a random access memory 204, a data storage device 210, and a modem 206. The data storage device 210 may be any type of non-volatile data storage device, including, for example, a floppy disk drive, a hard disk drive, a flash memory, a CD-ROM, a DVD-ROM, a CMOS memory with battery backup, etc. The data storage device 210 provides storage for software programs used by the intelligent radio 100. The software stored on the data storage device 210 may be upgraded by downloading new software from the Web. The data storage device 210 may also provide storage for digitized audio material, such as recorded Web radio broadcasts, CD-Audio, etc. The modem 206 is connected to a communications network 230, shown as a Public Switched Telephone Network (PSTN), by the network cable 102. Although the communications network 230 is shown as a PSTN network, one skilled in the art will recognize that the network 230 may also be a cable television (CATV) network, a satellite network, or any other communications network. In one embodiment, the network 230 comprises both a Direct TV/PC satellite connection that provides information to the intelligent radio 100 at high speed (e.g., 400,000 bytes per second or more), and a PSTN network connection so the intelligent radio can upload information back to the ISP 232 (because many Direct TV/PC connections are only one-way). In yet another embodiment, the satellite network is a two-way satellite network that uses the satellite for both download and upload. In one embodiment, the satellite network uses the hidiumTM system developed, in part, by the Motorola Corp.

Optionally, a telephone 229 is connected to a first port of a codec 260. A second port of the codec 260 is provided to the CPU 202. The codec provides digital-to-analog conversion and analog-to-digital conversion for the telephone 229. The codec 260 also provides standard telephone interface signals, such as a ringing signal, to the telephone 229, and telephone status conditions, such as receiver up or receiver down, to the CPU 202. In some embodiments, the codec 260 and the modem 206 may be combined as a telephone modem. The telephone 229 may be connected even when the network 230 is not a telephone network.

The modem 206 provides an interface between the CPU 202 and the communications network 230 and the operational characteristics of the modem 206 are determined by the type of communications network 230. Thus, if the network 230 is a PSTN network, then a telephone modem is used; if the network 230 is a CATV network, then a cable modem is used, etc. In a preferred embodiment, the modem 206 is integral to the intelligent radio 100. In other embodiments, the modem 206 is provided in a separate enclosure. An Internet Service Provider (ISP) 232 provides the user with a connection from the communications network 230 to the Web via the Internet 234. Note that FIG. 2 shows functional elements, but not necessarily hardware configurations. Thus, for example, the modem 206 may be implemented in software on the CPU 202. The CPU 202 may be a Digital Signal Processor (DSP). The CPU 202 may comprise a single computer processor, or multiple computer processors. In one embodiment, the CPU 202 comprises two processors, a DSP and a general purpose microprocessor. In one embodiment, the modem 206 is provided in a plug-in module such that the intelligent radio can be configured for different types of computer networks by simply changing the modem plug-in to suit the type of network being used.

The CPU 202 provides data to the display device 112. The CPU 202 receives user inputs from the command button 121, the tuning control 114, the button bar 120, the select button 118, and the cursor control 116. The CPU 202 provides digitized audio samples to an input of a Digital-to-Analog Converter (DAC) 220. The analog audio output of the DAC 220 is provided to an amplifier 222. In a preferred embodiment, the DAC 220 and the amplifier 222 are each two-channel devices, providing left and right stereo channels. A left channel output of the amplifier 222 is provided to the left channel speaker 106 and a right channel output of the amplifier 222 is provided to the right channel speaker 108. The volume control 110 controls the gain of the amplifier 222.

As shown in the preferred embodiment in FIG. 2, the other optional audio sources such as the cassette device 130, an AM tuner 240, an FM tuner 242, and an external input 244 also provide inputs to the amplifier 222. Other optional audio sources may be provided, such as, for example, an audio CD, a DVD, a digital audio tape unit, etc. The CPU 202 controls the cassette device 130, the AM tuner 240, the FM tuner 242, and other optional audio sources. A line output from the amplifier 222 may also be provided to a record input of the cassette device 130.

As described above, the button bar 120 is used to select one of the audio sources. When the button bar 120 is set to “AM,” the intelligent radio 100 operates in an AM radio mode. In the AM radio mode, an analog output from the AM tuner 240 is provided to the amplifier 222. Also in the AM radio mode, the display device 112 displays the frequency of an AM station selected by the AM tuner 240. The user may use the tuning control 114 to select a desired AM station. The AM mode is optional.

An analog output from a microphone 250 is provided to an analog input of an analog-to-digital converter 252. A digital output from the analog-to-digital converter 252 is provided to the CPU 202. The microphone 250 and converter 252 allow for voice commands to control the intelligent radio. The microphone 250 and converter 252 are optional. In some embodiments, a microphone is also placed in a wireless remote so that voice commands can be provided from the wireless remote.

When the button bar 120 is set to “FM,” the intelligent radio 100 operates in an FM radio mode. In the FM radio mode, the analog audio output from the FM tuner is provided to the amplifier 222, and the display device 112 displays the frequency of the FM station selected by the FM tuner 242. The FM mode is also optional.

When the button bar 120 is set to “Cassette,” the intelligent radio 100 operates in a cassette playback mode. In the cassette playback mode, analog output from the cassette player is provided to the amplifier 222, and the display device 112 displays information relating to the cassette playback. The cassette playback mode is also optional. The cassette device 130 may also optionally be configured to provide a record capability such that the cassette can be used to record audio information from any of the other modes. Thus, for example, the cassette can be used to record FM radio, AM radio, or Web radio broadcasts.

When the button bar 120 is set to “Web,” the intelligent radio 100 operates in a Web Radio mode. In the Web Radio mode, the intelligent radio 100 uses the modem 206 to connect to the ISP 232. The ISP 232 provides a list of available Web broadcasts, and access to the Internet 234, so that the various Web broadcasts can be received by the intelligent radio 100. In the Web Radio mode, the display device 112 is used to select a Web broadcast and to provide information about the selected Web broadcast.

FIGS. 3A through 3E show various displays provided by the display device 112 while in the Web Radio mode. FIG. 3A shows a default display 300 that appears while a Web broadcast is being received. FIG. 3B shows a menu display that allows the user to select one of the command and setup displays shown in FIGS. 3C-3E.

The display 300, shown in FIG. 3A, includes information about the Web broadcast including the type of broadcast (e.g., “Newscast”), the Web address (URL) of the source for the broadcast (e.g., http:://www/npr.org), a description of the broadcast (e.g., “National Public Radio 1997”), a broadcast format (e.g., “Streaming RealAudio”), etc.

FIG. 3B shows a menu display 320 that allows the user to access the various setup and control displays shown in FIGS. 3D-3E. The user activates the menu display 320 by pressing the command button 121. The display 320 provides a menu list 322 that lists the various other command displays. The list 322 may provide: a “Tune Station” command for activating a tune-station display 340, shown in FIG. 3E; a “Select Language” command for activating a select-language display 310, shown in FIG. 3C; and a “Select List” command for activating a select-list display 322, shown in FIG. 3D. The list 322 may also provide commands to activate other displays (not shown) such as “Setup,” to initialize the intelligent radio, “Scan Stations,” to get a new list of Web broadcast stations from the ISP 232, and “Define Station,” to manually define a Web broadcast station not listed by the ISP 232. The list 322 may also provide commands to activate other displays such as “Set Clock,” and “Set Alarm,” to provide optional clock and alarm clock modes for the display device 112.

The display 320 also provides a scroll bar 321 to allow the user to scroll through the list 322 and select an item (command) from the list. Scrolling may be accomplished by using either the cursor control 116 or the tuning control 114. The user uses the cursor control 116 or the tuning control 114 to highlight a desired menu item in the list 322, and then the user presses the select button 118 to select the highlighted menu item.

The select-language display 310, shown in FIG. 3B, allows the user to elect to receive Web broadcasts in one or more selected languages. The display 310 provides a list of available languages 312 and a scroll bar 314 for scrolling through the list 312. Each item in the list 312 corresponds to a language (e.g., English, French, etc.) and each item is provided with a checkbox 313. If a checkbox 313 is checked, then the corresponding language is enabled. The display 310 also provides an OK button 315, a Cancel button 316, a Clear-All button 317, and a Select-All button 318. The Clear-All button 317 clears all of the checkboxes 313, and the Select-All button 318 checks all of the checkboxes 313. The user “presses” one of the buttons 315-318 by using the cursor control 116 to highlight a desired button and then pressing the select button 118 to “press” the highlighted button.

The select-list display 330, shown in FIG. 3D, allows the user to select a preferred type of program material (e.g., Sports, Weather, News, All, etc.). The display 330 includes a list 332 of program types and a scroll bar 331. The user uses the cursor control 116 or the tuning control 114 to highlight a desired program type from the list 332, and then the user presses the select button 118 to select the highlighted program type.

The select-broadcast display 340, shown in FIG. 3E, allows the user to select a Web broadcast. The display 330 includes a list 342 of the available Web broadcasts having the proper language (as selected in the select language display 310) and the desired program type (as selected in the select-list display 331). The user uses the cursor control 116 or the tuning control 114 to highlight a desired broadcast from the list 342, and then the user presses the select button 118 to select the highlighted program type. Each item in the list 342 is provided with a checkbox 343. If the checkbox 343 is checked, then the corresponding broadcast is a preferred (or “fast-tune”) broadcast. The user may scroll through the fast-tune broadcasts by using the tuning control 114 from the default display 300 shown in FIG. 3A, without having to activate the select-broadcast display 340. This provides a convenient shortcut feature to allow the user to quickly tune to stations that the user regularly listens to.

FIG. 4 illustrates a data-entry display 450 that allows the user to input alphanumeric text (e.g., the telephone number of the ISP 232 or a URL). The display 450 includes a text prompt 451 to prompt the user for the desired data. The display also includes an on-screen keyboard 452, a text display 453, an OK button 454 and a Cancel button 455. The user enters text by using the cursor control 118 to highlight a desired character on the on-screen keyboard 452 and then pressing the select button 118 to enter the highlighted character into the text display 453. The OK button 454 and the Cancel button 455 are “pressed” in the same fashion.

FIG. 5 is a flowchart 500 that begins at a start block 501 and illustrates the Web Radio mode process. The process advances from the start block 501 to a decision block 502, where the process checks a status flag to determine whether or not the intelligent radio software needs to be initialized (setup). If setup is needed, then the process advances to a process block 504; otherwise, the process jumps over the setup steps to a process block 514. In the process block 504, the process obtains a phone number for the desired ISP 232. The phone number may be obtained from a default phone number stored in the intelligent radio software, or by prompting the user through the data-entry display 450. Once the phone number has been obtained, the process advances to a process block 506, where the modem 206 dials the telephone number and establishes a modem connection with the ISP 232. Once the connection is established, the process advances to a process block 508 where the user establishes an account with the ISP 232.

In one embodiment, the user is prompted for a password that is stored on the data storage device 210 or entered using the data-entry display 450. Establishing an account may include other actions, such as creating a usemname for the user, changing the phone number used to access the ISP 232, and entering information about the user and the user's account. Once an account is established, the process advances to a process block 510 where a list of available Web radio broadcast stations is downloaded to the intelligent radio 100 from the ISP 232 and stored on the storage device 210. Lists of available languages and program types are also downloaded and stored on the storage device 210. Once the lists are downloaded, the process advances to a hang-up block 512 wherein the modem 206 terminates the network connection (e.g., hangs-up the phone). Upon hang-up, the setup process is complete, and the process advances to the process block 514.

In the process block 514, the modem dials the ISP 232 and then advances to a process block 516 where the intelligent radio 100 logs on to the user's account at the ISP 232. The hang-up, redial, and logon (blocks 512, 514, and 516, respectively) is desirable when using a PSTN, because the initial telephone call, placed in the block 506, is typically a long-distance call or a toll-free (e.g., a 1-800) call. By contrast, the telephone call placed in the block 514 is typically a local call. When using a non-PSTN network (e.g., a cable modem, a satellite network, etc.) then the hang-up, redial, and logon (blocks 512, 514, and 516, respectively) is typically omitted.

Once the user is logged on, the process advances to a process block 518 where the user selects (tunes) a Web radio broadcast station. Once a Web broadcast has been selected, the process advances to a process block 520 where the intelligent radio 100 receives the Web broadcast. The CPU 202 decodes and decompresses the received data as necessary and then sends the decompressed data to the DAC 220 where it is converted to an analog signal that is subsequently played on the speakers 106, 108. The process remains in the process block 520 while the user listens to the Web broadcast.

If the user tunes to a new Web broadcast station (e.g., by turning the tuning control 114 or by activating the select-broadcast display 340) then the process loops back to the process block 518, selects the new station, and returns to the process block 520.

FIG. 6A illustrates the information management and data processing functions 600 provided by a Web Radio site 602 (e.g., www.webradio.com). Access to the Internet site 602 is made possible by the Internet access provided by the ISP 232. The Internet site 602 provides a list of Web radio broadcast stations for the user and optionally other value-added services that enhance the operation of the intelligent radio 100. For example, the Internet site 602 may provide a list of available program sources and streaming audio programming. The site 602 may also maintain user profile comprising a list of preferred Internet “broadcast stations”. The site 602 also provides special download capabilities such that the user can download information and software into the intelligent radio. The site 602 also provides upload capabilities such that the user can upload information, such as preferences, etc., from the intelligent radio 100 to the site 602. For example, the site 602 can provide a customized list of stations for each user and voicemail capability. The site 602 may provide reformatting of streaming audio data into a format better suited for the intelligent radio.

In one embodiment, the site 602 also provides Web telephone capabilities to the intelligent radio 100, such that the user can use the intelligent radio as a telephone to talk to other users that are connected to the Internet. In one embodiment of the Web telephone, the codec 260 is used to digitize speech from a microphone in the handset of the telephone 229. The digitized speech is sent over the network 230 to the ISP. The ISP forwards the digitized speech to a remote user. Similarly, the ISP provides digitized speech from the remote user to the intelligent radio. The intelligent radio uses the codec 260 to convert the digitized speech into analog signals that are played on the speakers 106 and 108 or a speaker in the handset of the telephone 229.

In yet another embodiment, the intelligent radio provides voice email in connection with the site 602. To receive email, text-to-voice software in the site 602 is used to convert email text into digitized voice data as words spoken in the user's desired language. The digitized voice data is provided to the intelligent radio where it is converted to an analog signal and played on the speakers 106 and 108 or a speaker in the handset of the telephone 229. To receive email, the user speaks into the microphone 250 or the microphone in the handset of the telephone 229 and the spoken words are converted into digitized speech by the intelligent radio. The intelligent radio sends the digitized speech to the site 602 where it is converted into email text and then emailed to the recipient. The software to convert speech to text and text to speech is provided in the site 602 in order to minimize the cost and complexity of the intelligent radio. Alternatively, the software to convert speech to text and text to speech is provided in the intelligent radio.

In one embodiment, the site 602 also provides special formatting and markup protocols that are tailored to the intelligent radio display 112. Most existing Internet sites are geared towards a computer or television and assume that a user has a large, high resolution, color monitor. Most existing Internet sites also assume that a user is accessing the site by using a Web browser such as Netscape Navigators or Microsoft Internet Explorer™. These browsers support high level protocols such as HyperText Markup Language (HTML). The display 112, may be relatively smaller, and relatively less capable than a traditional computer monitor. In some embodiments, the display 112 does not necessarily need all of the capabilities and complexity of HTML and is thus better served by information that is formatted for the display 112 and that is expressed in a markup language that is suited to the needs of the intelligent radio 100, without the overhead and complexity of HTML.

When the user connects to the Internet site, information is passed along a first data stream to an account management block 604. The block 604 provides account management functions relating to the user's account with the ISP 232. The account management block passes data to a user preference block 606, which retrieves user profile information and user preferences specified by the user. Information regarding the user preferences may be stored by the ISP 232, or downloaded from the intelligent radio 100 as needed.

Information is also passed from the process block 602 along a second data stream to a program management block 608. The program management block 608 accesses a language variety database 610 to determine which languages are available, and a program variety database 612 to determine which types of programs are available. The program management block 608 also accesses program sources such as live broadcasts 620, archived broadcasts 624, stored music 626, and other streaming audio sources 622.

User profile information from the user preference block 606 and program data from the program management block 608 are provided to a program list block 616, which constructs a list of available Web programs (broadcasts) that fit the user's preferences. The list constructed in the block 616 is passed to the intelligent radio 100.

FIG. 6B shows the conceptual relationship between the site 602 and other Web sites that supply streaming audio information, such as a site 630, a site 631, and a site 632. The Internet provides the ability to transfer data between any two of the sites 602, 630632. The user connects, through the ISP 232, to the site 602. The site 602 provides links to the sites 630-632 through the programming lists provided by the site 602. If the user selects a streaming audio program from one of the sites 630-632, then the site 602 provides the necessary link to the selected site. In some embodiments, the site 602 provides the link information to the intelligent radio 100, and the intelligent radio 100 makes a “direct” connection to the selected site. In other embodiments, the site 602 links to the selected site, receives the streaming audio data, reformats the data if desired, and then sends the streaming audio data to the intelligent radio 100.

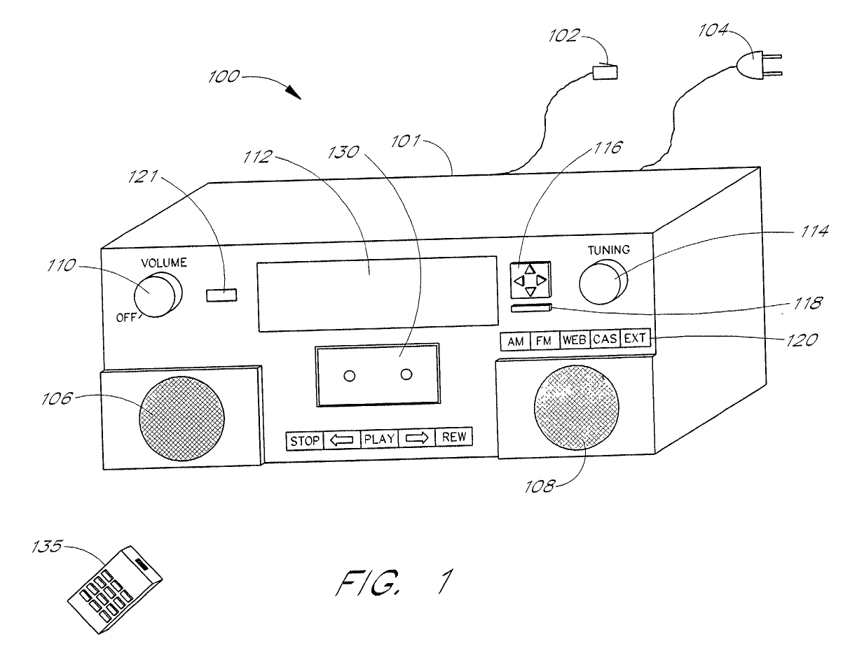

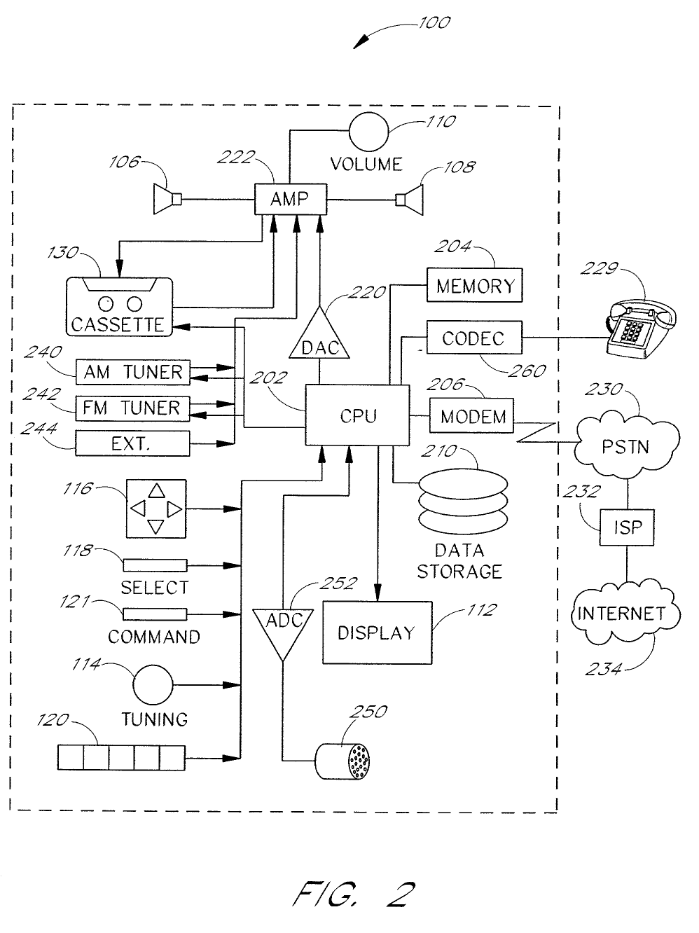

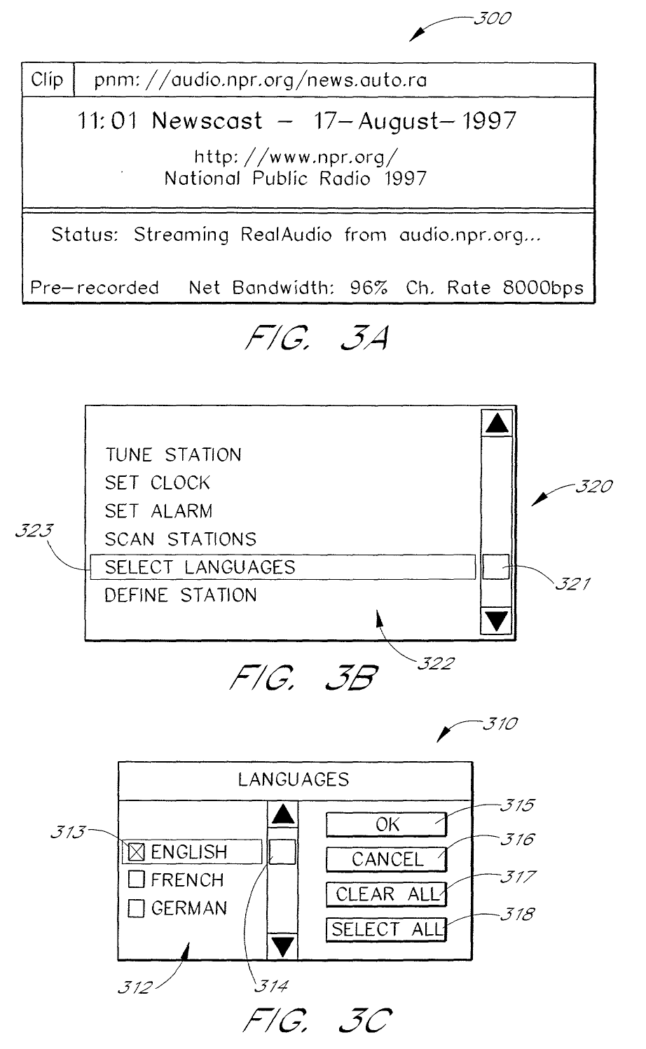

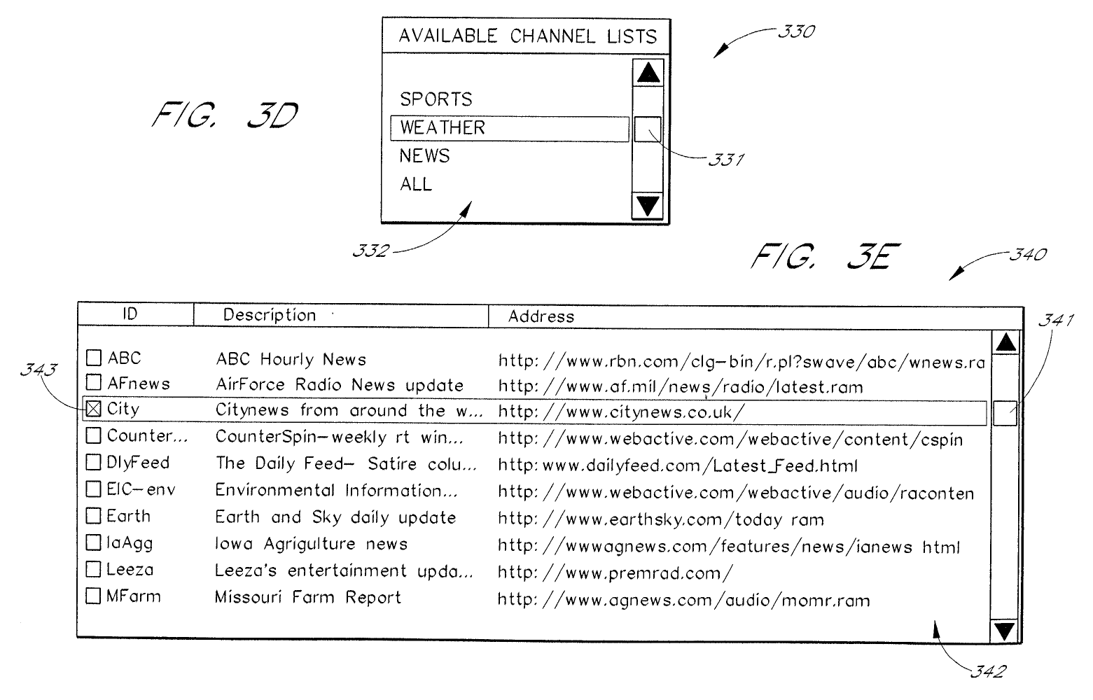

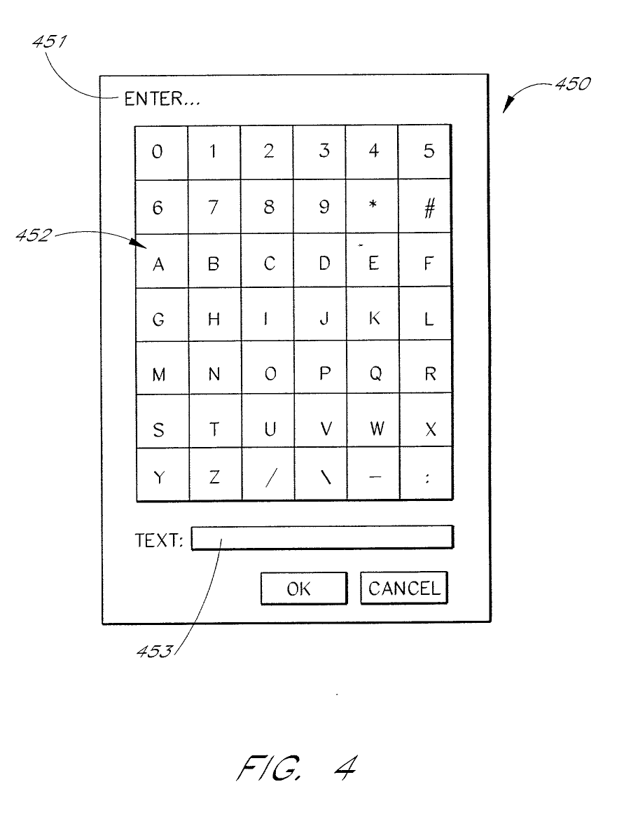

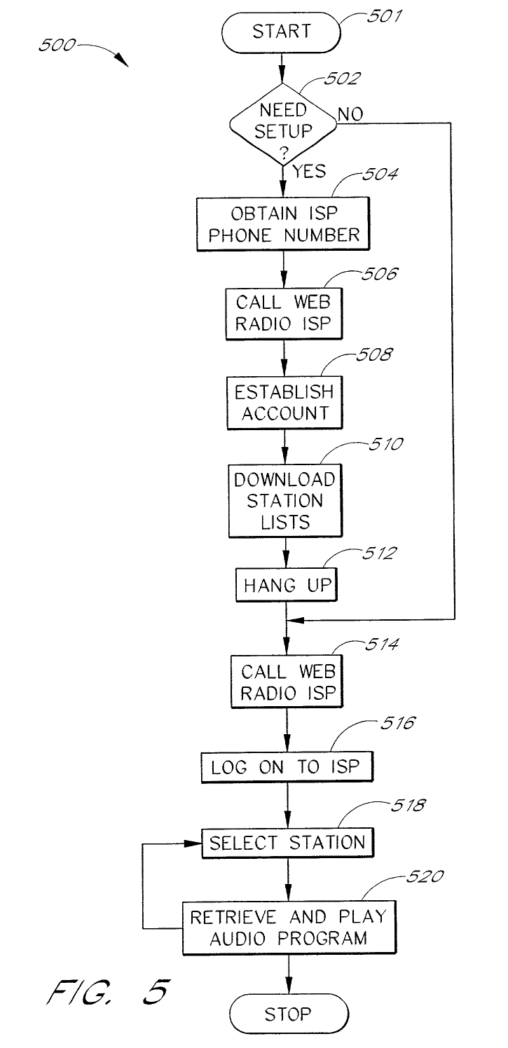

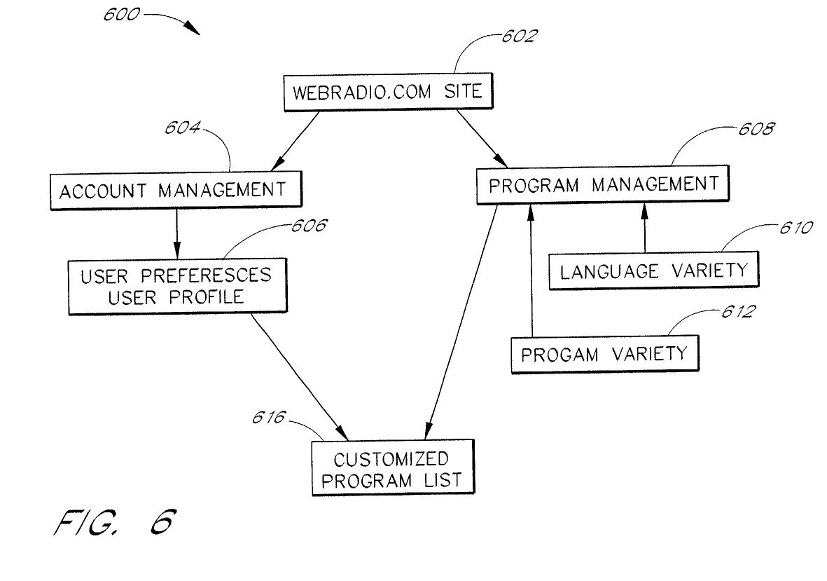

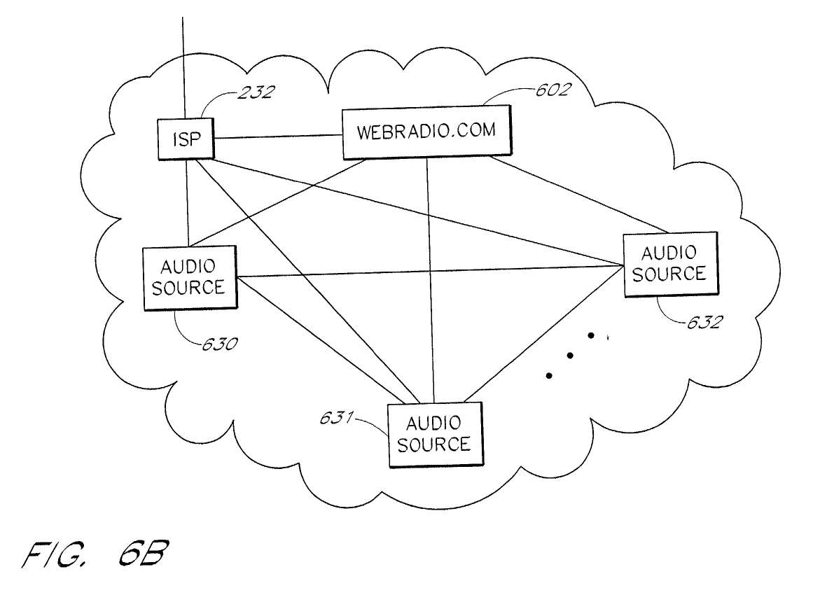

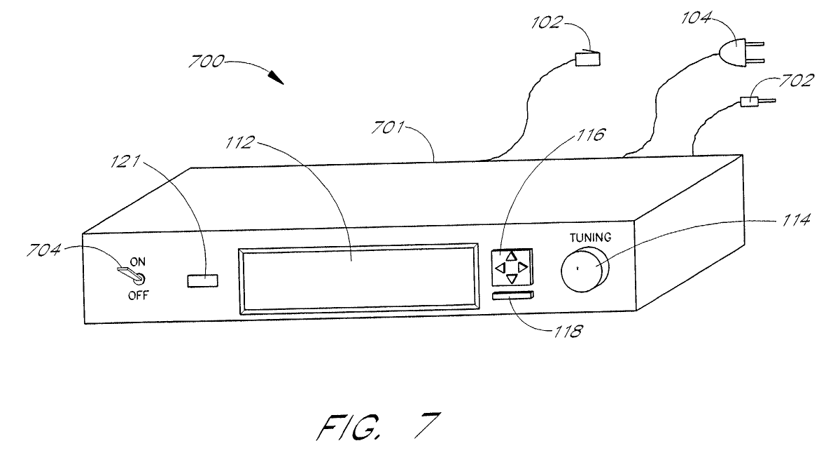

FIG. 7 illustrates an embodiment of an intelligent radio tuner 700. The tuner 700 is mounted in an enclosure 701 and connects to household AC power through a power cord 104, to a network through a network cable 102, and to an audio system through an audio line 702. User controls are mounted on the front of the enclosure 701 and include an on-off switch 704, a command button 121, a cursor control 116, a select button 118, and a tuning control 114. The cursor control 116 provides up, down, left, and right movements of a cursor or other entity on a display device 112. Also mounted on the front of the enclosure 701 is the display device 112, which provides information to the user.

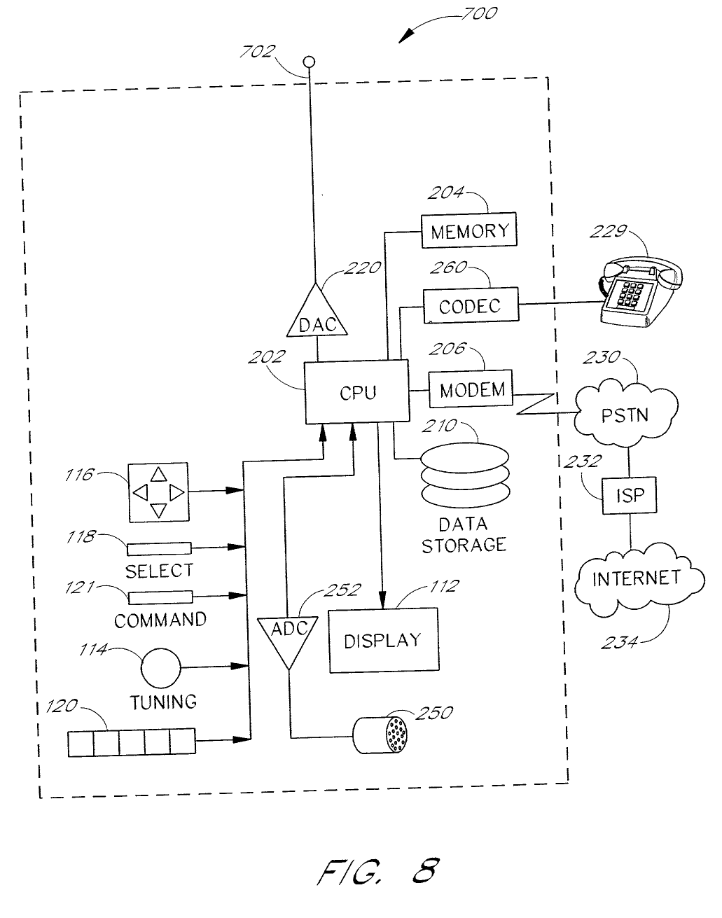

FIG. 8 is a block diagram of the functional elements of the intelligent radio configured as a tuner 700. The tuner 700 comprises the Central Processor Unit (CPU) 202 that is used to run the intelligent radio software. The CPU 202 is connected to the random access memory 204, the data storage device 210, the modem 206, and the codec 260. The data storage device 210 may be any type of non-volatile data storage device, including, for example, a floppy disk drive, a hard disk drive, a flash memory, a CD-ROM, a DVD-ROM, a CMOS memory with battery backup, etc. The modem 206 is connected to a communications network 230, shown as a Public Switched Telephone Network (PSTN). Although the communications network 230 is shown as a PSTN network, one skilled in the art will recognize that the network 230 may also be a cable television (CATV) network, a satellite network, or any other communications network. The modem 206 provides an interface between the CPU 202 and the communications network 230 and the operational characteristics of the modem 206 are determined by the type of communications network 203. Thus, if the network 230 is a PSTN network, then a telephone modem is used; and if the network 230 is a CATV network, then a cable modem is used, etc. An Internet Service Provider (ISP) 232 provides the user with a connection from the network 230 to the Web via the Internet 234.

The CPU 202 provides data to the display device 112. The CPU 202 receives user inputs from the command button 121, the tuning control 114, the select button 118, and the cursor control 116. The CPU 202 provides digitized audio samples to an input of a Digital-to-Analog Converter (DAC) 220. The analog audio output of the DAC 220 is provided to the audio output 702. In a preferred embodiment, the DAC 220 is a two-channel device, providing left and right stereo channels.

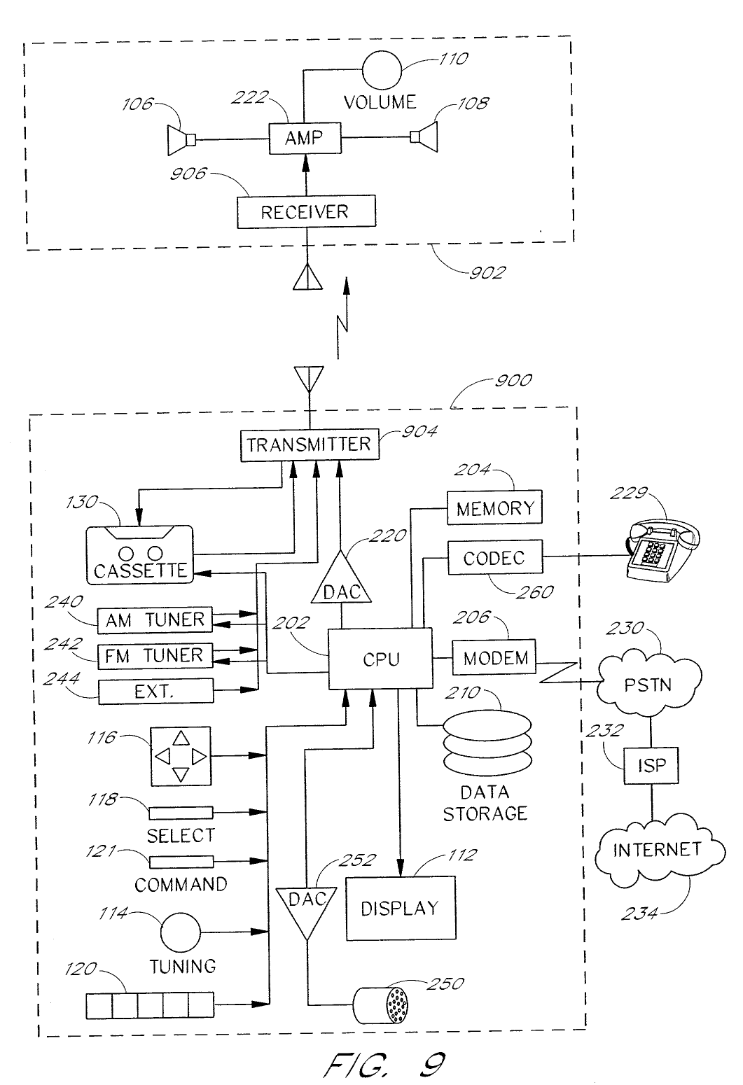

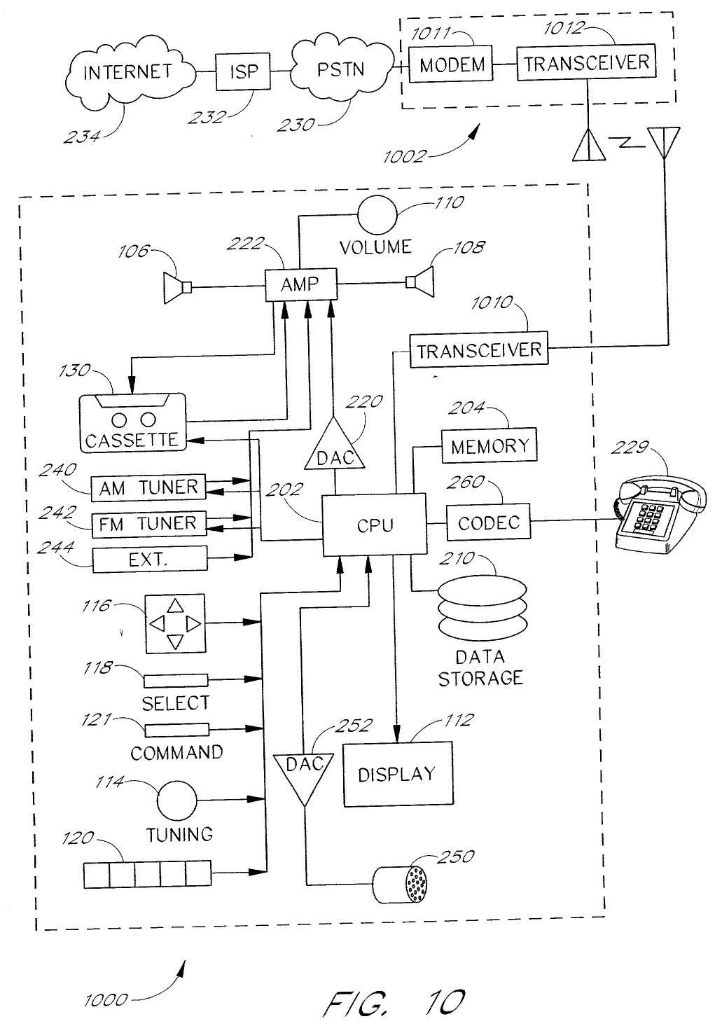

FIG. 9 is a block diagram of the functional elements of an embodiment of an intelligent radio that provides for remote playback. FIG. 9 shows a base unit 900 that is connected to the communications network 230. The base unit 900 receives streaming audio from the Web and transmits the audio information to a remote playback unit 902.

The base unit 900 is similar in most respects to the intelligent radio except that the amplifier 222, the loudspeakers 106 and 108, and the volume control 110 are not located in the base unit 900, but rather are located in the remote playback unit 902. In the base unit, the DAC 220, the cassette device 130, the AM tuner 240, the FM tuner 242, and the external input 244 are connected to a transmitter 904 rather than the amplifier 222. The transmitter 904 provides a transmitted signal to a receiver 906 in the remote unit 902. The receiver 906 provides an audio output to the amplifier 222.

The base unit 900 receives the streaming audio information from the Internet 234 and uses a transmission carrier to retransmit the audio information to one or more remote units 902. The transmitter 904 and the receiver 906 may use any form of communication for the transmission carrier, including radio frequency communication, infrared communication, ultrasonic communication, etc. In one embodiment, the transmitter 904 may be a low power FM (Frequency Modulation) transmitter compatible with standard FM broadcast bands, such that the remote playback unit 902 can be a standard FM transistor radio or a stereo receiver. In yet another embodiment, the transmitter 904 may be a low power AM (Amplitude Modulation) transmitter compatible with standard AM broadcast bands, such that the remote playback unit 902 can be a standard AM transistor radio or a stereo receiver.

In other embodiments, the base unit 900 may also include an amplifier 222, loudspeakers 106 and 108, and a volume control 110 such that the base unit 900 can provide both playback of the audio information and transmission of the audio information to the remote unit 902.

FIG. 10 is a block diagram of the functional elements of an embodiment of an intelligent radio that provides for remote access, comprising a base unit 1002 and an intelligent radio 1000. The base unit 1002 comprises a transceiver 1012 coupled to a modem loll. The modem 1011 is connected to the communications network 230. The modem 1011 receives data from the ISP and provides the data to the transceiver 1012, which then transmits the data to a transceiver 1010 in the intelligent radio 1000. The transceiver 1010 transmits data from the intelligent radio 1000 to the transceiver 1012. The transceiver 1012 provides the data from the intelligent radio 1000 to the modem 1011, which sends the data to the ISP 232.

The intelligent radio 1000 is similar in most respects to the intelligent radio 100 shown in FIG. 2, with the addition of the transceiver 1010. A data input/output port of the transceiver 1010 is provided to the processor 202 and a Radio Frequency (RF) input/output port of the transceiver 1010 is provided to an antenna. Also, in the intelligent radio 1000, the modem 206 is optional (because network communications are handled by the transceiver 1010 rather than the modem 206).

The transceivers 1010 and 1012 use any suitable means for communication, including, for example, optical communication, radio communication, etc. In a preferred embodiment, the transceivers 1010 and 1012 are radio transceivers that use spread-spectrum communication techniques at a frequency of approximately 2.4 GHz. The combination of the base unit 1002 and the intelligent radio 1000 provides a capability similar to that provided by a cordless telephone. The base unit 1002 can be located near a network connection point (e.g., a telephone outlet), and the intelligent radio 1000 can be conveniently placed anywhere within the range of the base unit 1002. The two-way communication link between the transceiver 1010 and the transceiver 1012 provides a cordless connection to the network 230.

Other Embodiments

While the above description contains many specifics, these should not be construed as limitations on the scope of the invention, but rather as an exemplification of preferred embodiments thereof. The various user controls and buttons can be relocated, combined, reconfigured, etc. Most of the user controls and buttons can even be omitted entirely in favor of voice-activated commands. One skilled in the art will recognize that many of the various features, and capabilities described in connection with the intelligent radio 100, are also applicable to other embodiments as well, including the embodiments described in connection with FIGS. 7-10. One skilled in the art will also recognize that other embodiments are contemplated, including, for example, handheld intelligent radios, and intelligent radios for boats, cars, trucks, planes, and other vehicles, etc.

One skilled in the art will recognize that these features, and thus the scope of the present invention, should be interpreted in light of the following claims and any equivalents thereto.

What is claimed is:

1. A radio for receiving, with substantially equal convenience, broadcasts from both local radio stations and from the world wide web, comprising:
a visual display for providing information to a user;
tuner circuitry for receiving radio frequency signals from radio broadcast stations;
one or more audio amplifiers;
one or more loudspeakers operably connected to said audio amplifiers;
a modem for transmitting and receiving digital data over a communications network;
a data storage device; and
a software program stored on said data storage device, said software program configured to use said modem to connect to an Internet service provider to receive digitized audio broadcasts from said Internet service provider, said program further configured to provide a select broadcast display to allow the user to selectably connect a program broadcast to the input of said one or more audio amplifiers either from a local AM or FM radio station or from the world wide Web SO that to the user, reception of a broadcast from the world wide Web is no more complicated than listening to a local FM or AM radio station.

2. A method for providing, with substantially equal convenience, access to audio broadcasts over the world wide Web and access to broadcasts from local radio stations, comprising the steps of:
using a modem for transmitting and receiving digital data over a communications network to an Internet service provider;
using a radio tuner to receive audio broadcasts from local radio stations; and
providing a stored software program for allowing selection of a Web broadcast with substantially the same controls and convenience as selecting a local radio broadcast.

3. The method of claim 2, wherein said local radio stations are FM broadcast radio stations.

4. The method of claim 2, wherein said local radio stations are AM broadcast radio stations.

5. A self-contained intelligent radio for receiving audio broadcasts over the world wide Web, comprising:
a visual display for providing information to a user;
a modem for transmitting and receiving digital data over a communications network;
a data storage device;
one or more loudspeakers; and
a software program stored on said data storage device, said software program configured to use said modem to connect to an Internet service provider, receive digitized audio broadcasts from said Internet service provider, and play said audio broadcasts on said speakers, said software further configured to provide: a menu display that allows the user to select a command; a select language display that allows the user to specify a desired language; a program material display to allow the user to select a type of program material; and a select broadcast display to allow the user to select a program broadcast.

6. A self-contained intelligent radio for receiving audio broadcasts over the world wide Web, comprising:
a visual display for providing information to a user;
a network interface for transmitting and receiving digital data over a communications network;
a data storage device; and
a software program stored on said data storage device, said software program configured to use said network interface to connect to an Internet service provider, and receive digitized audio broadcasts from said Internet service provider.

7. The self-contained intelligent radio of claim 6, wherein said software program is upgraded by downloading data over said communications network.

8. The self-contained intelligent radio of claim 6, further comprising one or more loudspeakers.

9. The self-contained intelligent radio of claim 6, wherein said communications network is a telephone network.

10. The self-contained intelligent radio of claim 6, wherein said communications network is a satellite network.

11. The self-contained intelligent radio of claim 6, wherein said communications network is a cable television network.

12. The self-contained intelligent radio of claim 6, further comprising a transmitter configured to transmit audio information using a transmission carrier.

13. The self-contained intelligent radio of claim 12, wherein said transmission carrier is a radio frequency carrier.

14. The self-contained intelligent radio of claim 12, wherein said transmission carrier is an infrared carrier.

15. The self-contained intelligent radio of claim 12, wherein said transmission carrier is a spread-spectrum carrier.

16. The self-contained intelligent radio of claim 12, further comprising a receiver for receiving audio information transmitted by said intelligent radio.

17. The self-contained intelligent radio of claim 6, wherein said software is configured to provide a menu display that allows the user to select a command.

18. The self-contained intelligent radio of claim 6, wherein said software is configured to provide a select language display that allows the user to specify a desired language.

19. The self-contained intelligent radio of claim 6, wherein said software is configured to provide a program material display to allow the user to select a type of program material.

20. The self-contained intelligent radio of claim 6, wherein said software is configured to provide a select broadcast display to allow the user to select a program broadcast.

21. The self-contained intelligent radio of claim 6, wherein said software is configured to provide a data-entry display to allow the user to input alpha-numeric text.

22. The self-contained intelligent radio of claim 6, wherein said software is provided as firmware.

23. The self-contained intelligent radio of claim 22, wherein said software is stored in non-volatile semiconductor memory.

24. The self-contained intelligent radio of claim 6, further comprising a display and a plurality of user controls.

25. The self-contained intelligent radio of claim 24, wherein said user controls include at least one tuning knob, said tuning knob configured to select a Web radio broadcast.

26. The self-contained intelligent radio of claim 24, wherein said user controls are configured to allow the user to operate the intelligent radio in a manner that is similar to the operation of a conventional radio.

27. The self-contained intelligent radio of claim 24, wherein said display and one or more of said user controls are mounted on a front panel of said intelligent radio.

28. The self-contained intelligent radio of claim 6, wherein said network interface comprises a telephone modem.

29. The self-contained intelligent radio of claim 6, wherein said network interface comprises a cable modem.

30. The self-contained intelligent radio of claim 6, wherein said network interface comprises a satellite modem.

31. The self-contained intelligent radio of claim 6, wherein said network interface comprises a transceiver.

32. The self-contained intelligent radio of claim 31, wherein said transceiver comprises a spread-spectrum transceiver.

33. The self-contained intelligent radio of claim 6, further comprising a voicemodem.

34. The self-contained intelligent radio of claim 33, wherein said intelligent radio is configured to provide an Internet telephone mode.

35. An intelligent radio apparatus comprising:
a processor operatively coupled to a computer network; and
software loaded into a memory operatively coupled to said processor, software configured to:
provide a list of streaming audio programs for an intelligent radio;
provide access to said streaming audio programs; and
provide information formatted for a display in said intelligent radio.

36. The apparatus of claim 35, said software further configured to provide Internet telephone service to said intelligent radio.

37. The apparatus of claim 35, said software further configured to provide voicemail to said intelligent radio.

38. The apparatus of claim 35, wherein said list of streaming audio programs comprises a customized list.

39. The apparatus of claim 35, wherein said display has a display area less than twenty-five square inches.

40. The apparatus of claim 35, said software further configured to download software modules into a memory in said intelligent radio.

41. The apparatus of claim 35, wherein said processor is a digital signal processor.

42. The apparatus of claim 35, wherein said software is further configured to communicate with service routines running on a computer connected to said computer network.

43. The apparatus of claim 43, wherein said service routines provide added functionality to said software.

44. The apparatus of claim 44, wherein said added functionality comprises voice command recognition.

45. The apparatus of claim 45, wherein said added functionality comprises data conversion.

46. The apparatus of claim 45, wherein said added functionality comprises the ability to convert text messages into voice messages.

47. The apparatus of claim 45, wherein said added functionality comprises the ability to convert voice messages into text messages.

48. The apparatus of claim 45, wherein said added functionality comprises formatting a display screen.

49. The apparatus of claim 35, wherein said software is further configured to provide voice-activated commands.
